(19) United States
(12) Patent Application Publication
(10) Pub. No.: US 2011/0084799 A1
(43) Pub. Date: Apr. 14, 2011

(54) LOCK SYSTEM INCLUDING AN ELECTRONIC KEY AND A PASSIVE LOCK

(75) Inventor: Bradley W. Ficko, Manotick (CA)

(73) Assignee: Pitney Bowes Inc., Stamford, CT (US)

(21) Appl. No.: 12/577,850

(22) Filed: Oct. 13, 2009

(51) Int. Cl. G05B 19/00

(52) U.S. Cl. 340/5.65

(57) ABSTRACT

A lock system that includes a passively powered lock device having an electric lock mechanism and a key device having a power supply, wherein the key device stores a lock credential associated with the lock device. The key device is structured to be operatively coupled to the lock device. The key device is also structured to provide power to the lock device for powering the lock device and moving the electric lock mechanism from a locked condition to an unlocked condition when the key device is operatively coupled to the lock device. The lock device is structured to receive an authentication message from the key device, verify based on the authentication message that the key device stores the lock credential, and move the electric lock mechanism from the locked condition to the unlocked condition based on the verification that the key device stores the lock credential.

### FIELD OF THE INVENTION

The present invention relates to lock systems, and in particular, to a lock system that includes a powered electronic key and a passive lock that is powered by the electronic key.

### BACKGROUND OF THE INVENTION

In traditional lock systems, a unique physical key was required to unlock and open the associated lock. Because each lock has a corresponding key, people often carry many keys for the various locks that they access in their daily lives. Depending on the number of keys, this can become cumbersome.

More recently, electronic lock systems have been developed, such as those that are employed in many hotels. In one such system, a number of electronic locks are networked to a central computer system. An electronic key card is then issued for a particular lock and a code for the associated lock is generated by the central computer system and stored in a machine readable form on the key card, typically on a magnetic strip provided on the card. That same code is, through the network, stored in the lock. To unlock the lock, the key card is inserted into the lock, which reads the code from the key card (e.g., by reading the magnetic strip). If the code read from the card key matches the code stored in the lock, the lock is unlocked. In an alternative centralized system, rather than storing the code for the lock in the lock itself, it is maintained in a central storage area (e.g., a database) by the central computer system. After the code is read from the key card by the lock, the lock, through the network, checks it against the code stored in the central storage area. If the codes match, the lock is unlocked.

Another prior art electronic lock system is decentralized in nature. More specifically, each lock is a stand alone, battery powered device that is not connected to a central computer system. In this system, each key card carries two codes, an old code that was for the immediately prior use of the associated lock (e.g., the prior occupant of a hotel room), and a new code that is for the current use of the lock (e.g., the new/current occupant of the hotel room). The lock always stores one current code that will open the lock (initially the old code). When the current user inserts the key card into the lock for the first time, it reads the old code and the new code, recognizes that the old code matches the current code it is storing, and changes the current code to the new code. Thereafter (until changed again in this manner), the lock may be opened with the new code (and not the old code).

These systems, while effective, have certain drawbacks. For example, each system requires the locks to be constantly powered, typically through an internal battery. Also, in the centralized systems, numerous network connections are required and may, at times, result in slow unlocking transactions depending on the status of the network.

### SUMMARY OF THE INVENTION

In one embodiment, the invention provides a lock system that includes a passively powered lock device having an electric lock mechanism, wherein the lock device does not have an internal power supply and is not permanently connected to a power supply for providing power to the lock device. The lock system also includes a key device having a power supply, wherein the key device stores a lock credential associated with the lock device. The key device is structured to be operatively coupled to the lock device. The key device is also structured to provide power to the lock device for powering the lock device and moving the electric lock mechanism from a locked condition to an unlocked condition when the key device is operatively coupled to the lock device. The lock device is structured to receive an authentication message from the key device, verify based on the authentication message that the key device stores the lock credential, and move the electric lock mechanism from the locked condition to the unlocked condition based on the verification that the key device stores the lock credential.

In one particular embodiment, the lock credential includes an authentication certificate issued by an administrator of the lock system. The authentication certificate includes certain certificate data that is signed by a private key of the administrator, and the authentication message includes the authentication certificate. Preferably, the certificate data includes a public key of the key device, an identifier identifying the lock device, and right of access information, wherein the right of access information is usable by the lock device to determine whether at any particular time the authentication certificate is currently valid to unlock the lock device. The right of access information may specify an expiration date of the authentication certificate, a time period of validity of the authentication certificate, and a classification of a user of the key device used to determine when the authentication certificate is valid for use. In a particular embodiment, the authentication request message includes a nonce, and the authentication message further includes first data signed by a private key of the key device, the first data including the nonce, an identifier identifying the key device, and the identifier identifying the lock device.

In an alternative embodiment, the lock credential includes a secret cryptographic key. In this embodiment, the authentication request message includes an encrypted challenge comprising a challenge encrypted using the secret cryptographic key, and the authentication message comprises an encrypted response comprising a response based on the challenge encrypted using the secret cryptographic key. In another alternative embodiment, the lock credential includes a private key of a public/private key pair. In this embodiment, the authentication message comprises a digital signature generated using the private key.

The lock device preferably has a first connector mechanism and the key device preferably has a second connector mechanism, wherein the key device is operatively coupled to the lock device by the first connector mechanism being coupled to the second connector mechanism. The first connector mechanism may be a first USB connector and the second connector mechanism may be a second USB connector.

The key device may further include an input apparatus structured to enable the input of personal authentication information into the key device, wherein the key device is adapted to generate the authentication message only if the personal authentication information is successfully verified by the key device. The input apparatus may be, for example, a keypad for inputting a password or the like or a biometric sensor for scanning a fingerprint or the retina of the user.

In another embodiment, the invention provides a method of unlocking a lock device using a key device operatively coupled to the lock device and storing a lock credential associated with the lock device. The method includes steps of providing power to the lock device from the key device, wherein the lock device does not having an internal power supply and is not permanently connected to a power supply for providing power to the lock device, generating an authentication message in the key device using the stored lock credential, sending the authentication message to the lock device, verifying in the lock device that the key device stores the lock credential based on the authentication message, and unlocking the lock device using only the power received from the key device based on the verification that the key device stores the lock credential. The lock credential in this embodiment may have any of the forms described above or elsewhere herein.

Therefore, it should now be apparent that the invention substantially achieves all the above aspects and advantages. Additional aspects and advantages of the invention will be set forth in the description that follows, and in part will be obvious from the description, or may be learned by practice of the invention. Moreover, the aspects and advantages of the invention may be realized and obtained by means of the instrumentalities and combinations particularly pointed out in the appended claims.

### BRIEF DESCRIPTION OF THE DRAWINGS

The accompanying drawings illustrate presently preferred embodiments of the invention, and together with the general description given above and the detailed description given below, serve to explain the principles of the invention. As shown throughout the drawings, like reference numerals designate like or corresponding parts.

FIG. 1 is a block diagram of a lock system according to one particular embodiment of the present invention;

FIG. 2 is a block diagram of one particular embodiment of the key device of the lock system of FIG. 1;

FIG. 3 is a block diagram of one particular embodiment of the lock device of the lock system of FIG. 1;

FIG. 4 is a flowchart showing one embodiment of a method of unlocking a particular lock device using a particular key device according to an aspect of the present invention;

FIG. 5 is a block diagram of an alternative embodiment of a key device that provides additional security by providing an input apparatus through which a user may input some personal authentication information for verification by the key device before the key device will function to unlock a lock device; and

FIG. 6 is a schematic diagram of a system by which lock credentials in the various embodiments described herein may be stored on the key devices as desired.

### DESCRIPTION OF THE PREFERRED EMBODIMENTS

Directional phrases used herein, such as, for example and without limitation, top, bottom, left, right, upper, lower, front, back, and derivatives thereof, relate to the orientation of the elements shown in the drawings and are not limiting upon the claims unless expressly recited therein.

As employed, herein, the statement that two or more parts or components are “coupled” together shall mean that the parts are joined or operate together either directly or through one or more intermediate parts or components.

As employed herein, the statement that two or more parts or components “engage” one another shall mean that the parts exert a force against one another either directly or through one or more intermediate parts or components.

As employed herein, the term “number” shall mean one or an integer greater than one (i.e., a plurality).

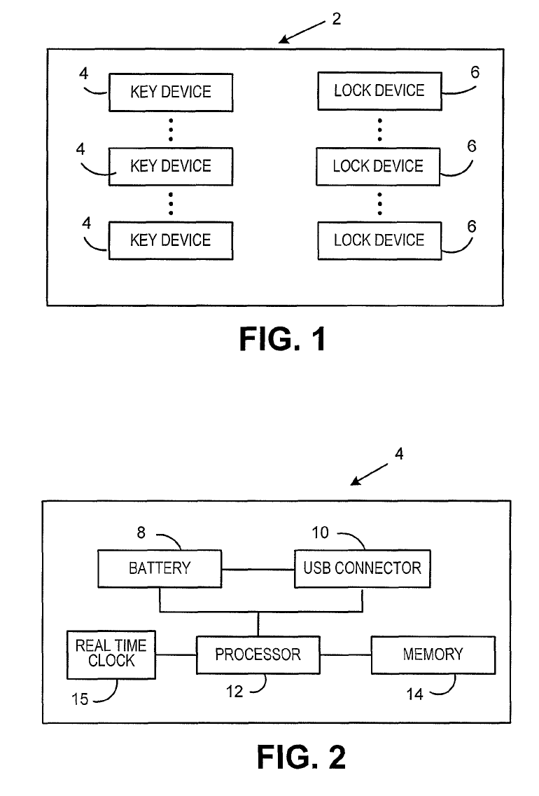

FIG. 1 is a block diagram of a lock system 2 according to one particular embodiment of the present invention. Lock system 2 includes a number of key devices 4 and a number of lock devices 6 for locking, for example, a number of rooms such as a number of rooms in a hotel or other building or group of buildings. Each key device 4 has a unique identifier, such as an identification number, associated therewith. Similarly, each lock device 6 has a unique identifier, such as an identification number, associated therewith. In addition, as described in greater detail herein, in order to unlock any particular one of the lock devices 6, a key device 4 must have a lock credential for that lock device 6 that was issued by an administrator of the lock system 2. Thus, each key device 4 may be selectively provided with one or more of such lock credentials by the administrator so that a holder of the key device 4 will be able to unlock the associated lock device 6 as desired. Furthermore, as described below, each lock device 6 is a passively powered device, meaning that it does not have its own dedicated power supply, such as, without limitation, an internal battery, and is not permanently wired to a power circuit/system. Instead, each lock device 6 is powered by a key device 4 that is operatively coupled thereto during the unlocking process.

FIG. 2 is a block diagram of one particular embodiment of the key device 4. The key device 4 includes a battery 8, such as, without limitation, a rechargeable battery like a Li ion battery, and a USB (universal serial bus) connector 10 operatively coupled to the battery 8. Alternatively, the battery 8 may be replaced by some other type of power supply device such as, without limitation, a supercapacitor. For reasons described elsewhere herein, the USB connector 10 is preferably a male connector that is structured to be selectively coupled to a female USB connector of another device (i.e., a lock device 6 as described below). The key device 4 also includes a processor 12 operatively coupled to the battery 8 and to a memory 14. The processor 12 may be, for instance, and without limitation, a microprocessor (μP), a microcontroller or some other suitable processing circuit or device, and interfaces with the memory 14. The memory 14 can be any of a variety of types of internal and/or external storage media such as, without limitation, RAM, ROM, EPROM(s), EEPROM(s) and combinations thereof, and the like that provide a storage register for data storage such as in the fashion of an internal storage area of a computer, and can be volatile memory or nonvolatile memory. The memory 14 additionally includes a number of routines executable by the processor 12 for implementing the invention as described herein and for the processing of data in accordance with the invention as described herein. The routines can be in any of a variety of forms such as, without limitation, software, firmware, and the like. The routines include one or more routines for implementing the USB protocol for transmitting and receiving data and/or power through the USB connector 10, and one or more cryptographic algorithms for use as described herein. The routines implementing the USB protocol enable the key device 4 to act as a USB host device, meaning that it will control all USB transactions. Key device 4 can also include a real time clock 15 coupled to the processor.

In addition, the memory 14 will store one or more lock credentials for use in unlocking one or more associated lock devices 6. As will be appreciated, each key device 4 will store lock credentials for only those lock devices 6 that the holder/user of the key device 4 is authorized to be able to unlock. The lock credentials themselves, and the authentication process employed with such credentials in order to unlock the associated lock device 6, may take on a variety of different forms and formats. A number of embodiments of particular lock credentials and associated authentication processes are described elsewhere herein.

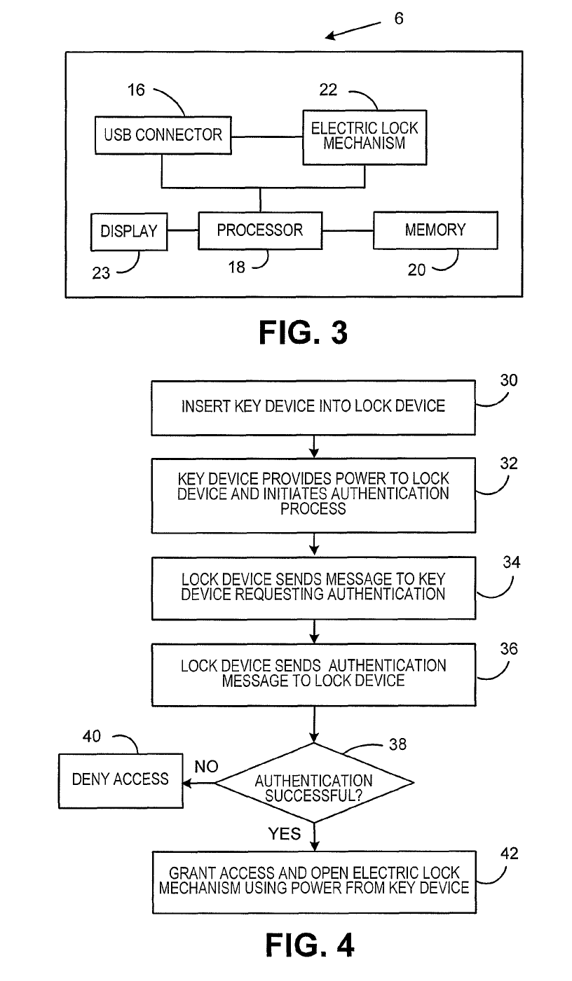

FIG. 3 is a block diagram of one particular embodiment of the lock device 6. The lock device 6 includes a USB (universal serial bus) connector 16 structured to be selectively coupled to the USB connector 10 of a key device 4. The USB connector 16 is preferably a female connector so that when the lock device 6 is positioned in association with a door, for example, the lock device 6 will be able to be flush with an exterior surface of the door or an exterior surface of the lock device 6 itself, rather than protruding therefrom. The lock device 6 also includes a processor 18 operatively coupled to the USB connector 16 and to a memory 20. The processor 18 may be, for instance, and without limitation, a microprocessor (μP), and interfaces with the memory 20. The memory 20 can be any of a variety of types of internal and/or external storage media such as, without limitation, RAM, ROM, EPROM(s), EEPROM(s) and combinations thereof, and the like that provide a storage register for data storage such as in the fashion of an internal storage area of a computer, and can be volatile memory or nonvolatile memory. The memory 20 additionally includes a number of routines executable by the processor 18 for implementing the invention as described herein and for the processing of data in accordance with the invention as described herein. The routines can be in any of a variety of forms such as, without limitation, software, firmware, and the like. The routines include one or more routines for implementing the USB protocol for transmitting and receiving data and receiving power through the USB connector 16 from a key device 4, and one or more cryptographic algorithms for use as described herein.

The lock device 6 also includes an electric lock mechanism 22 that is operatively coupled to the USB connector 16 and the processor 18 and that is structured to move from a locked condition to an unlocked condition in response to the receipt of electric current. More specifically, the electric lock mechanism 22 is a lock mechanism wherein the motion of a latch or bolt (or similar mechanism) is controlled (for example, by way of a solenoid, a magnet, a motor or the like) by applying a voltage to the terminals of the mechanism. A number of suitable electric lock mechanisms 22 are well known in the art. The lock device 6 may also include a display device 23, such as, for example, one or more colored LED's or an LCD display for use as described below. Lock device 6 can also include a real time clock (not shown) in addition to or in lieu of real time clock 15 in key device 4.

FIG. 4 is a flowchart showing one embodiment of a method of unlocking a particular lock device 6 using a particular key device 4 according to an aspect of the present invention. The method begins at step 30, wherein the key device 4 is inserted into the lock device 6. In the preferred embodiment, this is done by inserting the male USB connector 10 of the key device 4 into the female USB connector 16 of the lock device 6 so that the two are operatively coupled to one another. Next, at step 32, the battery 8 of the key device 4 provides power to the lock device 6 through the USB connection formed between the USB connector 10 and the USB connector 16. Also, an authentication initiation message is sent to the lock device 6 to start the authentication process. At step 34, in response to being powered up and receiving the authentication initiation message as just described, the processor 18 of the lock device 6 sends an authentication request message to the processor 12 of the key device 4 through the USB connection formed between the USB connector 10 and the USB connector 16. The authentication request message preferably includes the identifier for the lock device 6 so that the key device 4 will know which lock credential to use if it stores multiple lock credentials. At step 36, in response to receipt of the authentication request message, the key device 4, using the lock credential associated with the lock device 6, generates an authentication message structured to establish that the key device 4 indeed possesses a valid lock credential associated with the lock device 6 and thus is authorized to unlock the lock device 6, and sends the authentication message to the processor 18 of the lock device 6 through the USB connection formed between the USB connector 10 and the USB connector 16. At step 38, in response to the receipt of the authentication message, the processor 18 determines whether the key device 4 can be successfully authenticated based on the received authentication message, i.e., it determines whether the key device 4 indeed possesses a valid lock credential associated with the lock device 6 and thus is authorized to unlock the lock device 6. If the answer at step 38 is no, then, at step 40 access is denied, meaning that the electric lock mechanism 22 is not unlocked. In addition, a visual indication of denial of access, such as the lighting of a red LED provided as part of the display 23 or the display of an “access denied” message on display 23 may also be provided at step 40. If, however, the answer at step 38 is yes, meaning that authentication has been successful, then, at step 42, the processor 18 causes a voltage/current to be provided to electric lock mechanism 22 causing it to enter an unlocked condition. In addition, a visual indication of the grant of access, such as the lighting of a green LED provided as part of the display 23 or the display of an “access granted” message on display 23 may also be provided at step 42.

Thus, as demonstrated in FIG. 4, a passive lock device 6 may be provided wherein it only requires and consumes power when an attempt to unlock it is made. Also, the passive lock device 6 does not need to store or otherwise access (e.g., through a network) the credentials of a plurality of individuals who have authorized access (i.e., who can unlock the lock device 6), but instead only needs to store a mechanism for verifying the authentication message received from the key device 4, a number of which are described below in connection with various particular embodiments. Furthermore, each powered key device 4 is able to store lock credentials issued to it by the administrator of the lock system 2 for a number of lock devices 6. An individual, therefore, only needs to carry and keep track of a single device while maintaining the ability to open potentially a large number of lock devices 6.

The authentication process shown in FIG. 4 (steps 34-38) may be performed in several different ways using a number of different types of lock credentials. A number of particular embodiments are described below.

In the preferred embodiment, each lock credential issued by the administrator to a particular key device 4 for a particular lock device 6 is an authentication certificate that includes: (i) certain certificate data, and (ii) a digital signature of the certificate data created using a private key of the administrator (the authentication certificate is thus said to be the certificate data signed by the private key of the administrator). The preferred certificate data includes: (i) the public key of the particular key device 4, (ii) the identifier of the particular lock device 6, and (iii) certain right of access information that is used determine under what circumstances the particular lock device 6 can be unlocked using an authentication certificate. For example, the right of access information may specify an expiration date after which the authentication certificate may no longer be used, a limited daily time period (e.g., 8 AM to 6 PM) during which the authentication certificate may only be used, or a user classification (e.g., employee, contractor, visitor, cleaning crew, etc.) which is used to determine when the authentication certificate may be used at any particular time (e.g., employees may be limited to 8 AM to 6 PM and cleaning crew may be limited to 10 PM to 6 AM). As described elsewhere herein, the right of access information will be checked by the lock device 6 during the unlocking process to determine whether the authentication certificate is currently valid for use.

In addition to the authentication certificate for each particular lock device 6 it is authorized to unlock, the key device 4 in this particular embodiment will also store the following additional information: (i) the private key of the key device 4, (ii) the public key of the key device 4, and (iii) the identifier of the key device 4. Also, each lock device 6 in this particular embodiment will store the following information: (i) the public key of the administrator of the lock system 2, (ii) the private key of the lock device 6, (iii) the identifier for the lock device 6, and (iv) a lock certificate issued by the administrator that includes the public key of the lock device 6.

In order to obtain an authentication certificate for a particular lock, the user of a key device 4 will present the public key and the identifier of the key device 4 signed by the private key of the key device 4 to the administrator. If the administrator is able to verify that signed request (using the public key of the key device 4), the administrator will issue (download) to the key device 4 an authentication certificate (as described above) for the lock device 6 in question.

The authentication process by which the key device 4 is able to unlock the lock device 6 using the authentication certificate for that lock device 6 is as follows. First, the key device 4 is inserted into the lock device 6 as described elsewhere herein. In response, the key device 4 will receive an authentication request message from the lock device 6. In this embodiment, the authentication request message will include the following information signed by the private key of the lock device 6: (i) a nonce, (ii) the identifier of the lock device 6, and (iii) the lock certificate of the lock device 6 (described above). The key device 4 will verify the authentication request message using the public key of the lock device 6 taken from the lock certificate. The key device 4 will then generate an authentication message that includes (1) the authentication certificate for the lock device 6, and (2) the following information signed by the private key of the key device 4: (i) the nonce, (ii) the identifier of the key device 4, and (iii) the identifier of the lock device 6. The lock device 6 will then attempt to verify the information in (2) using the public key of the key device 4 taken from the authentication certificate provided to the key device 4 for lock 6 by the administrator (as described above). If verification is successful, the lock device 6 will then attempt to verify the authentication certificate using the public key of the administrator. If this verification is successful, the lock device 6 will then check the right of access information to determine whether the authentication certificate is currently valid. If the authentication certificate is currently valid, then authentication will be considered to be successful (step 38 of FIG. 4), and the lock device 6 will be caused to be unlocked.

In one alternative embodiment, the authentication process is based on symmetric key cryptography (using an encryption algorithm such as AES or Twofish) and the lock credential of each lock device 6 includes a shared secret cryptographic key (unique to that lock device 6) that is stored by the lock device 6 and provided to each authorized key device 4 by the administrator. In addition, this embodiment also employs a challenge-response authentication wherein the lock device 6 sends a challenge to the key device 4 and the key device 4 must provide a valid response in return in order to be authenticated. More specifically, at step 34 of FIG. 4, the authentication request message sent by the lock device 6 will include a challenge that is encrypted with the shared secret key of the lock device 6. The key device 4, upon receiving the encrypted challenge, will decrypt it using the shared secret key of the lock device 6 that is stores. The key device 4 will then generate a response based on the decrypted challenge and encrypt that response with the shared secret key of the lock device 6. At step 36, the key device 4 will then send the encrypted response to the lock device 6 as part of the authentication message. At step 38, the lock device 6 will decrypt the received encrypted response using its stored secret key and then determine whether the decrypted response is valid, thus proving that the key device 6 was able to decrypt the challenge. For instance, the challenge may be some pseudo-randomly generated information, wherein the response will be some predetermined function of the challenge information. One well known example of such a protocol is known as Kerberos, wherein the challenge is an encrypted integer N, while the response is the encrypted integer N+1, proving that the other end was able to decrypt the integer N.

In another alternative embodiment, the authentication process is based on public key cryptography and digital signatures and the lock credential of each lock device 6 includes a private cryptographic key (unique to that lock device 6) of a particular private key/public key pair. In this embodiment, the lock device 6 will store the public key and the key device 4 will store the corresponding private key (provided to it by the administrator). At step 34, the lock device 6 will generate a piece of information and encrypt that information using the stored public key. The encrypted information is then sent to the key device 4 as part of the authentication request message. The key device 4, upon receiving the encrypted information, will decrypt it using the private key of the lock device 6 that is stores. The key device 4 will then sign the decrypted information using the private key of the lock device 6 that it stores. At step 36, the key device 4 will then send the signed decrypted information to the lock device 6 as part of the authentication message. At step 38, the lock device 6 will verify the signed decrypted information using the stored public key. If successful, the lock device 6 will be able to verify that the key device 4 has the proper private key.

In still another, although less secure, embodiment, each lock credential may include a passcode associated with one of the lock devices 6. The passcode for any particular lock device 6 will be provided by the administrator to any key device 4 that is authorized to unlock the particular lock device 6. That passcode must then be provided to the particular lock device 6 during the authentication process to unlock the lock device 6.

The embodiments described above are meant to be exemplary only and not limiting. Other authentication processes using various encryption algorithms and protocols are also possible.

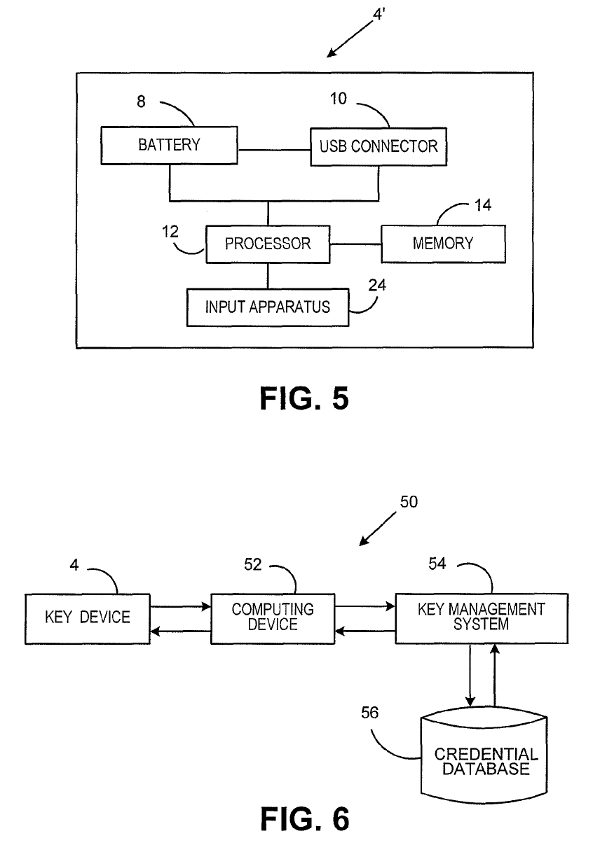

FIG. 5 is a block diagram of an alternative embodiment of a key device, designated 4′, that provides additional security by providing an input apparatus 24 through which a user of the key device 4′ may input some personal authentication information for verification by the key device 4 before the key device will function to unlock a lock device 6. For instance, the input apparatus 24 may comprise a keypad and the personal authentication information may be a password or PIN that, once entered, is compared by the processor 12 to a password or PIN stored by the memory 14. Alternatively, the input apparatus 24 may comprise a biometric sensor capable of reading a fingerprint and the personal authentication information may be a fingerprint of the authorized user stored by the memory 14. The read fingerprint is compared by the processor 12 to fingerprint stored in the memory 14, and the key device 4′ will only be able to function further if the fingerprints match. Other types of biometric sensors (e.g., a retinal scanner) and data are also possible.

FIG. 6 is a schematic diagram of a system 50 by which lock credentials in the various embodiments described herein may be stored on the key devices 4 as desired. The system 50 includes a computing device 52, such as a PC, a key management system 54 and a credential database 56. The credential database 56 stores information for generating the various embodiments of the lock credentials described herein for each lock device 6 in the lock system 2. In order to receive new lock credentials or to update existing lock credentials, a key device 4 is plugged into the USB port of the computing device 52. The computing device 52 includes software that is adapted to update the credential files that are stored on the key device 4. The computing device 52 also includes software that enables an administrator to identify which lock device or devices 6 the user of the key device 4 is to be granted access to. Once the particular lock device or devices 6 are identified, the computing device 52 securely communicates with the key management system 54 and transmits a list of the lock devices 6 thereto. The key management system 54 has access to the information stored in the credential database 56, and obtains the information needed for generating a lock credential as described herein for each identified lock device 6. The obtained information is then securely transferred to the computing device 52, which in turn creates the lock credentials and stores them in the memory 14 of the key device 6.

While preferred embodiments of the invention have been described and illustrated above, it should be understood that these are exemplary of the invention and are not to be considered as limiting. Additions, deletions, substitutions, and other modifications can be made without departing from the spirit or scope of the present invention. For example, while lock system 2 shown in FIG. 1 includes a plurality of key devices 4 and a plurality of lock devices 6, the present invention also contemplates a lock system having only one lock device 6 and a single or multiple key devices 4 for opening the lock device 6. Such a system may be employed in, for example, a home or an automobile. In addition, while the key device 4 and the lock device 6 communicate via a USB connection, it is contemplated that the present invention may employ other types of connector mechanisms (comprising one or more connectors) to communicate data between the key devices and lock devices and power from the key devices to the lock devices. Accordingly, the invention is not to be considered as limited by the foregoing description but is only limited by the scope of the appended claims.

What is claimed is:

1. A lock system, comprising:
a passively powered lock device, said lock device having an electric lock mechanism, said lock device not having an internal power supply and not being permanently connected to a power supply for providing power to said lock device; and
a key device having a power supply and storing a lock credential associated with said lock device;
wherein said key device is structured to be operatively coupled to said lock device, wherein said key device is structured to provide power to said lock device for powering said lock device and moving said electric lock mechanism from a locked condition to an unlocked condition when said key device is operatively coupled to said lock device, and wherein said lock device is structured to receive an authentication message from said key device, verify based on said authentication message that said key device stores said lock credential, and move said electric lock mechanism from said locked condition to said unlocked condition based on the verification that said key device stores said lock credential.

2. The lock system according to claim 1, said lock device having a lock processor and a lock memory, said lock memory storing one or more routines executable by said lock processor, said one or more routines having instructions for receiving said authentication message, verifying based on said authentication message that said key device stores said lock credential, and causing said electric lock mechanism to move from said locked condition to said unlocked condition based on the verification that said key device stores said lock credential.

3. The lock system according to claim 2, said key device having a key processor and a key memory, said key memory storing one or more second routines executable by said key processor, said one or more second routines having instructions for generating said authentication message using said stored lock credential and sending said authentication message to said lock device.

4. The lock system according to claim 3, said one or more routines executable by said lock processor further having instructions for generating an authentication request message and sending said authentication request message to said key device after receiving said power from said key device, wherein said authentication message is generated in response to said key device receiving said authentication request message.

5. The lock system according to claim 4, wherein said lock credential comprises an authentication certificate issued by an administrator of said lock system, said authentication certificate comprising certificate data signed by a private key of said administrator, and wherein said authentication message includes said authentication certificate.

6. The lock system according to claim 5, wherein said certificate data comprises a public key of said key device, an identifier identifying said lock device, and right of access information, said right of access information being usable by said lock device to determine whether at any particular time said authentication certificate is currently valid to unlock said lock device.

7. The lock system according to claim 6, wherein said right of access information specifies one of an expiration date, a time period of validity and a classification of a user of said key device.

8. The lock system according to claim 6, wherein said authentication request message includes a nonce, wherein said authentication message further includes first data signed by a private key of said key device, said first data including said nonce, an identifier identifying said key device, and said identifier identifying said lock device.

9. The lock system according to claim 4, wherein said lock credential comprises a cryptographic key.

10. The lock system according to claim 4, wherein said lock credential comprises a secret cryptographic key, wherein said authentication request message includes an encrypted challenge comprising a challenge encrypted using said secret cryptographic key, wherein said authentication message comprises an encrypted response comprising a response based on said challenge encrypted using said secret cryptographic key, wherein said one or more routines executable by said lock processor include one or more first cryptographic algorithms adapted to generate said encrypted challenge and decrypt said encrypted response, and wherein said one or more second routines include one or more second cryptographic algorithms adapted to decrypt said encrypted challenge and generate said encrypted response.

11. The lock system according to claim 9, wherein said lock credential comprises a private key of a public/private key pair, wherein said authentication message comprises a digital signature generated using said private key, and wherein said one or more routines are adapted to verify said digital signature using a public key of said public/private key pair.

12. The lock system according to claim 1, said lock device having a first connector mechanism and said key device having a second connector mechanism, said key device is operatively coupled to said lock device by said first connector mechanism being coupled to said second connector mechanism.

13. The lock system according to claim 12, said first connector mechanism being a first USB connector and said second connector mechanism being a second USB connector.

14. The lock system according to claim 1, wherein said key device further includes an input apparatus structured to enable the input of personal authentication information into said key device, and wherein said key device is adapted to generate said authentication message only if said personal authentication information is successfully verified by said key device.

15. The lock system according to claim 14, wherein said input apparatus is one of keypad and a biometric sensor.

16. A method of unlocking a lock device using a key device operatively coupled to said lock device and storing a lock credential associated with said lock device, comprising:
providing power to said lock device from said key device, said lock device not having an internal power supply and not being permanently connected to a power supply for providing power to said lock device;
generating an authentication message in said key device using said stored lock credential;
sending said authentication message to said lock device;
verifying in said lock device that said key device stores said lock credential based on said authentication message; and
unlocking said lock device using only said power received from said key device based on the verification that said key device stores said lock credential.

17. The method according to claim 16, further comprising generating an authentication request message in said lock device and sending said authentication request message to said key device after receiving said power from said key device, wherein said authentication message is generated in response to receiving said authentication request message.

18. The method according to claim 17, wherein said lock credential comprises an authentication certificate issued by an administrator of said lock system, said authentication certificate comprising certificate data signed by a private key of said administrator, and wherein said authentication message includes said authentication certificate.

19. The method according to claim 18, wherein said certificate data comprises a public key of said key device, an identifier identifying said lock device, and right of access information, wherein said unlocking comprises unlocking said lock device using only said power received from said key device based on the verification that said key device stores said lock credentials and determining in said lock device that said authentication certificate is currently valid to unlock said lock device based on said right of access information.

20. The method according to claim 19, wherein said right of access information specifies one of an expiration date, a time period of validity and a classification of a user of said key device.

21. The method according to claim 19, wherein said authentication request message includes a nonce, wherein said authentication message further includes first data signed by a private key of said key device, said first data including said nonce, an identifier identifying said key device, and said identifier identifying said lock device.

22. The method according to claim 17, wherein said lock credential comprises a cryptographic key.

23. The method according to claim 17, wherein said lock credential comprises a secret cryptographic key, wherein said authentication request message includes an encrypted challenge comprising a challenge encrypted using said secret cryptographic key, wherein said authentication message comprises an encrypted response comprising a response based on said challenge encrypted using said secret cryptographic key, wherein said generating an authentication message comprises decrypting said encrypted challenge, generating said response and encrypting said response to create said encrypted response, and wherein said verifying comprises decrypting said encrypted response.

24. The method according to claim 22, wherein said lock credential comprises a private key of a public/private key pair, wherein said authentication message comprises a digital signature generated using said private key, and wherein said verifying comprises verifying said digital signature using a public key of said public/private key pair.
